(19) United States
(12) Patent Application Publication
(10) Pub. No.: US 2006/0081524 A1
(43) Pub. Date: Apr. 20, 2006

(54) Membrane contactor and method of making the same

(76) Inventors: Amitava Sengupta, Charlotte, NC (US); Frank Wiese, Wuppertal (DE)

Correspondence Address: HAMMER & HANF, PC, 3125 SPRINGBANK LANE, SUITE G, CHARLOTTE, NC, 28226, US

(21) Appl. No.: 10/966,193

(22) Filed: Oct. 15, 2004

(51) Int. Cl. B01D 63/04

(52) U.S. Cl. 210/321.88; 210/450; 210/500.23; 210/338

(57) ABSTRACT

A hollow fiber membrane contactor includes a perforated center tube, a first mat comprising a first hollow fiber membrane, a second mat comprising a second hollow fiber membrane, a first tube sheet, a second tube sheet, a shell, and end caps. The first and second hollow fiber membranes are dissimilar. The first and second mats surround the center tube, and the first and second tube sheets affix the first and second mats to the center tube. The first hollow fiber membrane has a first lumen, and the second hollow fiber membrane has a second lumen. The first lumen may be open at the first tube sheet and closed at the second tube sheet while the second lumen may be open at the second tube sheet and closed at the first tube sheet. The shell surrounds the first and second mats, and it is sealed to the tube sheets. The end caps are affixed to the shell thereby defining headspaces therebetween the tube sheets and the end caps.

### FIELD OF INVENTION

This application discloses a hollow fiber membrane contactor, and method of making the same.

### BACKGROUND OF THE INVENTION

The use of hollow fiber membrane contactors to produce ultrapure liquids, which are essential to some industries, is generally known. Ultrapure liquids are free or substantially free from: minerals, ions, and gases. The most common dissolved or entrained gas is air, which has as its major components nitrogen, oxygen, and carbon dioxide.

Such hollow fiber membrane contactors are commercially available under the name of LIQUI-CEL® from Membrana a division of Polypore Inc. of Charlotte, N.C. and under the name of SEPAREL® from Dainippon Ink and Chemicals of Tokyo, Japan.

To facilitate manufacture of hollow fiber membrane contactors, the hollow fiber membranes are typically formed into a fabric (e.g., woven or knitted). The fabric is wound around a mandrel (e.g., a perforated center tube) and fixed into place by potting the fabric edges, with either thermosetting or thermoplastic materials, to form a unitized structure. This unit can then be inserted within a shell (housing) and sealed, i.e., with or without O-rings, to make a membrane contactor.

U.S. Pat. No. 3,827,562 discloses a blood filter device. The blood filter device utilizes a plurality of filter cloth layers disposed generally parallel to the path of blood flow and being supported in spaced relation and against collapse by a relatively coarse mesh arranged in layers and disposed between adjacent filter cloth layers.

U.S. Pat. No. 4,572,724 discloses a blood filter including a housing having upper and lower chambers with a cylindrical filter element disposed in the lower chamber.

U.S. Pat. No. 4,784,768 discloses a capillary filter arrangement for the sterilization of liquid media comprising two semipermeable capillary fiber bundles which are arranged adjacent each other in a single housing. The opposite openings of the housing are each sealed by end caps. The housing comprises at its ends cast layers in which the ends of the capillary fiber bundles are received. The ends of the first capillary fiber bundle are sealed with respect to the first distributing chamber and the ends of the second capillary fiber bundle are sealed with respect to the second distributing chamber so that the entire internal lumen of the first and second capillary fiber bundles respectively are in flow connection only with the second and first distributing chambers.

U.S. Pat. No. 5,362,406 discloses a leucocyte depletion filter assembly including a cylindrical housing having first and second chambers and an inlet into the first chamber and an outlet from the second chamber and a vent. A porous degassing element is positioned between the first and second chambers to remove gas from the liquid. The degassing element communicates with a vent covered with a liquophobic membrane, which allows gas but not the liquid to flow through the vent. A hollow, cylindrical filter element is positioned in the second chamber, and comprises a fibrous mass of microfibers capable of decreasing the leucocyte content of the liquid.

U.S. Pat. No. 5,468,388 discloses a pressurizable filter module for aqueous media having a degassing feature, the improvement comprising the use of a hydrophobic membrane between the inlet plenum of the filter module and the pressure relief valve.

U.S. Pat. No. 5,919,357 discloses a filter cartridge assembly comprising at least one filter cartridge, a first end cap, a second end cap, and a liquid transfer tube. The filter cartridge includes a housing with two ends, which contains a filter media. The first end cap is disposed on one end of the housing, and it includes a fluid inlet port, a fluid outlet port, a first fluid distributor and a vent including at least one hydrophobic membrane positioned in a channel formed in the first end cap that allows entrapped air to be removed from the cartridge. The second end cap is disposed on the second end of the housing, and it includes a product collection plenum, and a second fluid distributor that separates the filter media from the product collection plenum. The liquid transfer tube is disposed within the housing and extends from the product collection plenum to the fluid outlet port.

U.S. Pat. No. 6,623,631 discloses a vacuum filtration device for aqueous media that includes a hydrophilic tubular filter element in a cylindrical housing, and at least one hydrophobic gas-permeable membrane coupled with a gas bleed-off valve to allow the escape of air entrained in the filtration medium.

U.S. Pat. No. 6,635,179 discloses a filtration assembly, which is constructed so that two separate filtration compartments exist, resulting in redundant filtration of the fluid prior to infusion. Each compartment holds a filter, which preferably consists of a longitudinal bundle of semipermeable hollow fibers.

U.S. Pat. No. 6,719,907 discloses a dual-stage filtration cartridge, which includes a housing having a first end and an opposing second end. The housing has a primary fluid inlet and outlet at the first end of the cartridge. The housing also defines first and second filtration stages with the first filtration stage including first filtering elements disposed between the first and second ends of the housing. Each stage has a separate inter-lumen fiber space, but shares a common extra-lumen space. The primary fluid inlet communicates with the first filtering elements at the first end so that fluid flows through the first filtering elements toward the second end. The second filtration stage includes second filtering elements disposed between the first and second ends of the housing with the fluid outlet communicating with the second filtering elements at the first end.

U.S. Pat. No. 6,746,513 discloses a gas separation module, which includes an adsorbent filter medium inside the case that holds the active gas separation membrane. The adsorbent filter is positioned upstream of the membrane and is operative to extract from the feed gas contaminants which adversely affect membrane separation performance and which if not removed, would cause the membrane separation performance to deteriorate.

However, the above-mentioned prior art references fail to provide multiple separation capabilities in a single device; therefore, there is still a need for a multi-functional, high-purity membrane contactor, which provides multiple separation capabilities in a single device.

### SUMMARY OF THE INVENTION

A hollow fiber membrane contactor includes a perforated center tube, a first mat comprising a first hollow fiber membrane, a second mat comprising a second hollow fiber membrane, a first tube sheet, a second tube sheet, a shell, and end caps. The first and second hollow fiber membranes are dissimilar. The first and second mats surround the center tube, and the first and second tube sheets affix the first and second mats to the center tube. The first hollow fiber membrane has a first lumen, and the second hollow fiber membrane has a second lumen. The first lumen may be open at the first tube sheet and closed at the second tube sheet while the second lumen may be open at the second tube sheet and closed at the first tube sheet. The shell surrounds the first and second mats, and it is sealed to the tube sheets. The end caps are affixed to the shell thereby defining headspaces therebetween the tube sheets and the end caps.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a schematic illustration of a first embodiment of the instant invention;

FIG. 2 is a longitudinal cross-sectional view of a cartridge from the embodiment of FIG. 1;

FIG. 3 is a longitudinal cross-sectional view of a shell from the embodiment of FIG. 1;

FIG. 4 is a longitudinal cross-sectional view of a cartridge-shell assembly from the embodiment of FIG. 1;

FIGS. 5a, and 5b are cross longitudinal sectional views of end caps from the embodiment of FIG. 1; and

FIG. 6 is a schematic illustration of a second embodiment of the instant invention.

### DETAILED DESCRIPTION OF THE INVENTION

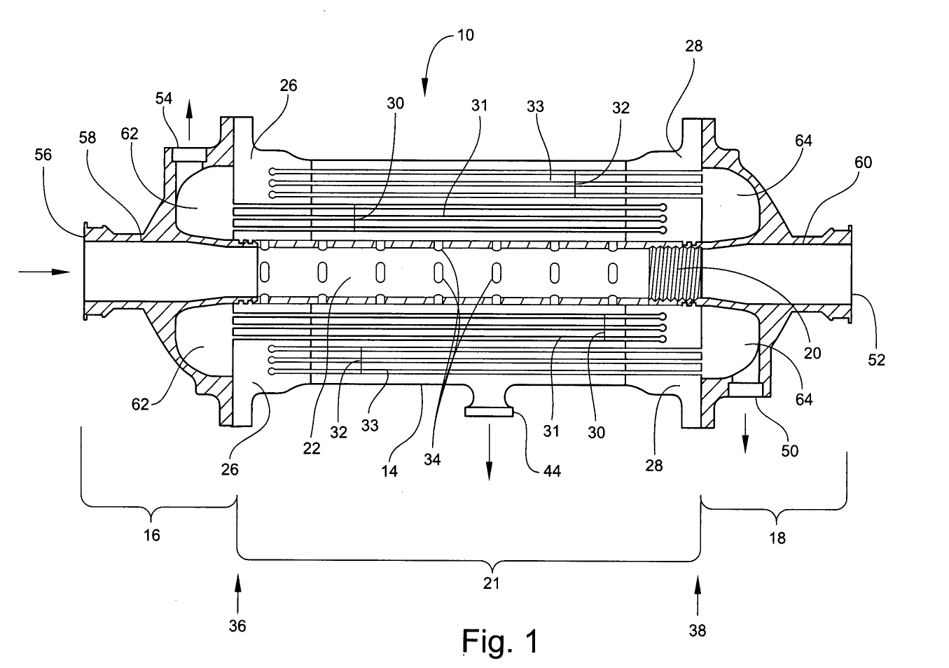

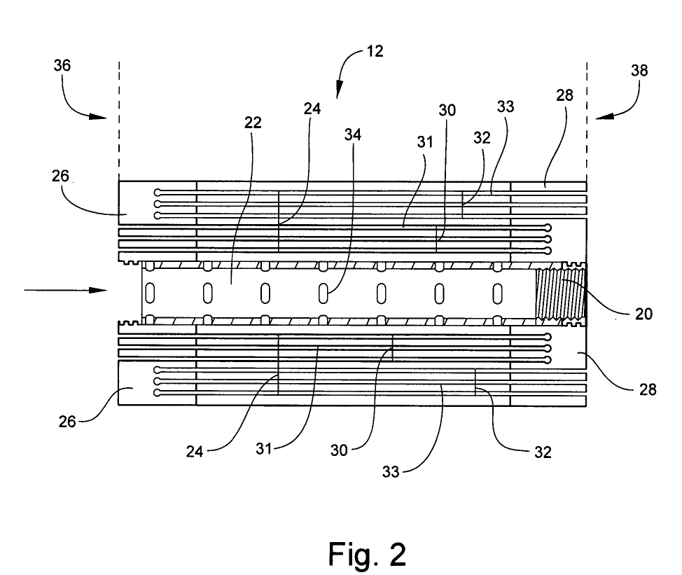

Referring to the drawings wherein like numerals indicate like elements, there is shown, in FIG. 1, a first embodiment of a hollow fiber membrane contactor 10. Contactor 10 includes four fundamental components, namely, a cartridge 12, a shell 14, a first end cap 16, and a second end cap 18, as shown in FIGS. 1-2.

Referring to FIG. 2, cartridge 12 includes a perforated center tube 22, a first membrane mat 30, a second membrane mat 32, a first tube sheet 26, and a second tube sheet 28. Additionally, cartridge 12 may include a plug 20. The first and second membrane mats 30 and 32 are wrapped around the center tube 22. The first tube sheet 26 affixes the first and second mats 30 and 32 to a first center tube end 36, and the second tube sheet 28 affixes the first and second mats 30 and 32 to a second center tube end 38.

The perforated center tube 22 may be made of any material, which possesses sufficient mechanical strength to provide the desired support for the mats 30 and 32, and the first and second tube sheets 26 and 28. The center tube may be made of a polymeric material, a metal, or a composite material. The center tube 22 may be made of any polyolefin, for example polyethylene. The center tube 22 includes a plurality of perforations 34. The center tube 22 possesses a channel, and the first center tube end 36 and the second center tube end 38. The second center tube end 38 may be closed via a plug 20. Plug 20 may, for example, be a permanent plug or a removable plug. Additionally, the second center tube end 38 may contain circumferential helical grooves (e.g. screw threads for the removable plug).

The first and second membrane mats 30 and 32 are dissimilar hollow fiber membrane mats. The first and second membrane mats 30 and 32 are each adapted to facilitate a different separation goal, examples of which include, but are not limited to, gas separation or particulate filtration. First and second mat 30 and 32, as discussed below in further detail, may be dissimilar with respect to their materials of construction, porosity ranges, Gurley number ranges, pore size ranges, and the like. The instant specification describes the instant invention with reference to only two dissimilar membrane mats for convenience only; however, the instant claimed invention is not so limited, and other configurations, for example three or more dissimilar membrane mats, are also included.

The first membrane mat 30 may comprise a plurality of first hollow fiber membranes 31. The first membrane mat 30 may have any thickness, i.e. a single layer of first hollow fiber membranes 31 or multiple layers of first hollow fiber membranes 31 arranged atop each other. For example, the first membrane mat 30 has a thickness, i.e. a single layer of first hollow fiber membranes 31 or multiple layers of first hollow fiber membranes 31 arranged atop each other, in the range of about 1 to about 25 cm. The first membrane mat 30 may be hydrophobic or hydrophilic. Furthermore, the first membrane mat 30 may be adapted to facilitate the degassing of a fluid; in the alternative, first membrane mat 30 may be adapted to facilitate microfiltration or ultrafiltration of a fluid. The first membrane mat 30 may also be adapted to facilitate the addition of a gas, a liquid, or particles to a fluid. The first membrane mat 30 may be constructed using processes well known in the art. Generally, in hollow fiber mat construction, hollow fiber membranes are knitted or woven into a mat.

The first hollow fiber membrane 31 may have a wall thickness in the range of about 5 to about 1000 μm, a porosity in the range of about 10 to about 80%, and a Gurley number in the range of about 1 to about 2000 seconds/10 cc. Gurley number refers to the time in seconds required to pass 10 cc of air through one square inch of product under a pressure of 12.2 inches of water. Additionally, the first hollow fiber membranes 31 may have any average pore size, for example the first hollow fiber membranes 31 may have an average pore size in the range of about 10 to about 2000 nanometer. The first hollow fiber membrane 31 may be any material, for example a polymer. The polymer, for example, may be any synthetic polymer, cellulose, or synthetically modified cellulose. Synthetic polymers include, but are not limited to, polyethylene, polypropylene, polybutylene, poly (isobutylene), poly (methyl pentene), polysulfone, polyethersulfone, polyester, polyetherimide, polyacrylnitril, polyamide, polymethylmethacrylate (PMMA), ethylenevinyl alcohol, fluorinated polyolefins, copolymers thereof, and blends thereof. Preferably, the first hollow fiber membranes 31 are made of polyolefins. The first hollow fiber membrane 31 may be a hydrophobic hollow fiber membrane suitable for gas transfer; in the alternative, the first hollow fiber membrane 31 may be a hydrophilic membrane suitable for particulate microfiltration or ultrafiltration. The first hollow fiber membrane 31 may include a porous or non-porous skin or a coating. Skinned hydrophobic hollow fiber membranes are commercially available, for example, under the trademark OXYPLUS® from Membrana GmbH of Wuppertal, Germany.

The second membrane mat 32 may comprise a plurality of second hollow fiber membranes 33. The second membrane mat 32 may have any thickness, i.e. a single layer of second hollow fiber membranes 33 or multiple layers of second hollow fiber membranes 33 arranged atop each other. For example, the second membrane mat 32 has a thickness, i.e. a single layer of second hollow fiber membranes 33 or multiple layers of second hollow fiber membranes 33 arranged atop each other, in the range of about 1 to about 25 cm. The second membrane mat 32 may be hydrophobic or hydrophilic. Furthermore, the second membrane mat 32 may be adapted to facilitate microfiltration or ultrafiltration; in the alternative, the second membrane mat 32 may be adapted to facilitate the degassing of a liquid. The second membrane mat 32 may also be adapted to facilitate the addition of a gas, a liquid, or particles to a fluid. The second membrane mat 32 may be constructed using processes well known in the art. Generally, in hollow fiber mat construction, hollow fiber membranes are knitted or weaved into a mat.

The second hollow fiber membrane 33 may have a wall thickness in the range of about 5 to about 1000 μm, a porosity in the range of about 10 to about 80%, and a Gurley number in the range of about 1 to about 2000 seconds/10 cc. Additionally, the second hollow fiber membranes 33 may have any average pore size, for example the second hollow fiber membranes 33 may have an average pore size in the range of about 10 to about 2000 nanometer. The second hollow fiber membrane 33 may be any material, for example a polymer, as described hereinabove. Preferably, the second hollow fiber membranes 33 are made of polyolefins. The second hollow fiber membrane 33 may be a hydrophilic hollow fiber membrane suitable for particulate microfiltration or ultrafiltration; in the alternative, the second hollow fiber membrane 33 may be a hydrophobic hollow fiber membrane suitable for gas transfer. The second hollow fiber membrane 33 may include a porous or non-porous skin or a coating. Hydrophilic hollow fiber membranes are commercially available, for example, under the trademark MicroPES® and UltraPES® from Membrana GmbH of Wuppertal, Germany.

Generally, the first hollow fiber membrane 31 has a first lumen and the second hollow fiber membrane 33 has a second lumen. The first lumen may be open at the first tube sheet 26 while the second lumen may be sealed at the first tube sheet 26, and the first lumen may be sealed at the second tube sheet 28 while the second lumen may be open at the second tube sheet 28. However, in the alternative, the first lumen may be sealed at the first tube sheet 26 while the second lumen may be open at the first tube sheet 26, and the first lumen may be open at the second tube sheet 28 while the second lumen may be sealed at the second tube sheet 28.

The first and second membrane mats 30 and 32 may be selected from the group consisting of a leaf mat, a looped mat, a tape mat, and combinations thereof. As used herein, leaf mat refers to a sheet of hollow fiber membranes arranged perpendicular to the length of the leaf mat. A looped mat, as used herein, refers to a folded sheet of hollow fiber membranes arranged perpendicular to the length of the looped mat. In the alternative, a looped mat may be a repeatedly folded single strand of a very long fiber membrane. A tape mat, as used herein, refers to a sheet of hollow fiber membranes arranged parallel to the length of the mat.

The first tube sheet 26 may be located near the first center tube end 36 while the second tube sheet 28 may be located near the second center tube end 38. The first and second tube sheets 26 and 28 may be cylindrical in cross section with sufficient thickness to provide support for membrane mats 30 and 32 and to withstand the pressure exerted on them during operation. The first and second tube sheets 26 and 28 function to hold membrane mats 30 and 32 in place, and to partition the contactor 10, into a shell side passageway, a first lumen side passageway, and a second lumen side passage way. The first and second tube sheets 26 and 28 may be comprised of any material, for example a potting material, which may be a thermoplastic or a thermoset. An exemplary thermoplastic potting material includes, but is not limited to, polyethylene. An exemplary thermoset potting material includes, but is not limited to, an epoxy.

Plug 20 functions to seal off the center tube 22 at the second center tube end 38. Plug 20 may be made of any material, for example polyethylene. Plug 20 may be any shape, for example plug 20 may be cylindrical in cross section with sufficient thickness to withstand the pressure exerted on it during operation. Plug 20 may have circumferential helical grooves, which are complimentary to the circumferential helical grooves of the second center tube end 38, to secure plug 20 to center tube 22. In the alternative, plug 20 may be an integral component of center tube 22, or it may be an integral component of second tube sheet 28. Plug 20 may be a permanent plug or a removable plug.

Spacers may be used to maintain the space between the wound layers of the membrane mats 30 and 32 to promote uniform distribution of fluid over their entire surfaces.

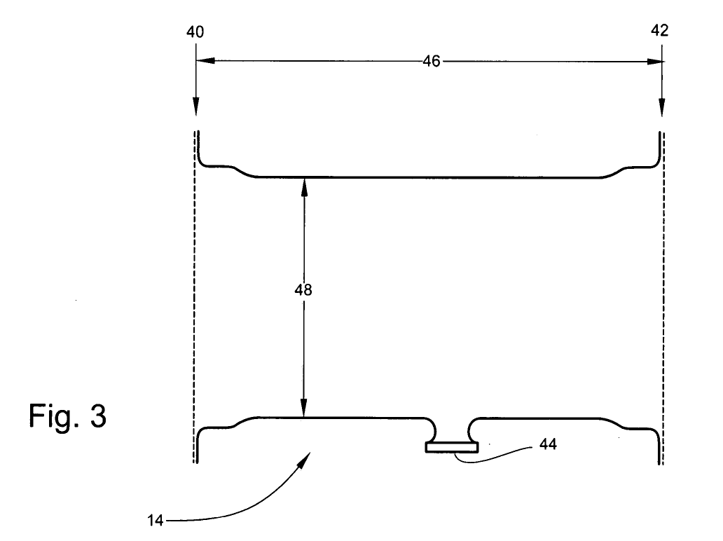

Referring to FIG. 3, shell 14 includes first and second ends 40 and 42. Additionally, shell 14 may include a retentate port 44. Shell 14 may be made of any material. For example, shell 14 is made of polyethylene, polypropylene, polyvinylidene fluoride (PVDF), polytetrafluoroethylene (PTFE), ethylene copolymer tetrafluoroethylene (ECTFE), fluorinated ethylene polymer (FEP), polyvinyl chloride (PVC), Acrylonitrile-butadiene-styrene (ABS), fiber reinforced plastic (FRP), a metal, or a composite material. Shell 14 may have any length 46, or any diameter 48. Shell 14 may be flanged at its first and second ends 40 and 42. For example, shell 14 may be flanged outwardly at its first and second ends 40 and 42.

Referring to FIG. 1, retentate port 44 is a non-permeate outlet means, which is adapted for removing the fluids, which do not permeate through the walls of the first and second hollow fiber membranes 31 and 33. Retentate port 44 is generally a port, nozzle, fitting, or other opening. Depending on the application of the contactor 10, the non-permeate may be the product of interest.

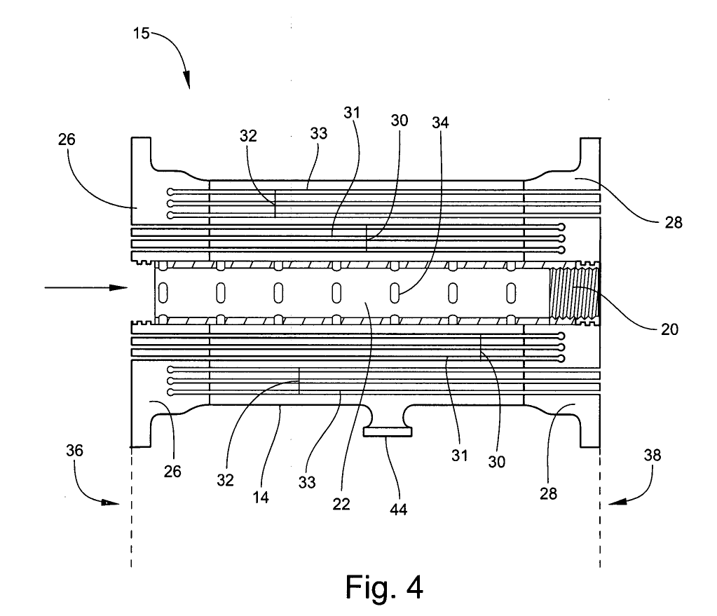

Referring to FIG. 4, cartridge 12 is disposed within shell 14 thereby forming cartridge-shell assembly 15.

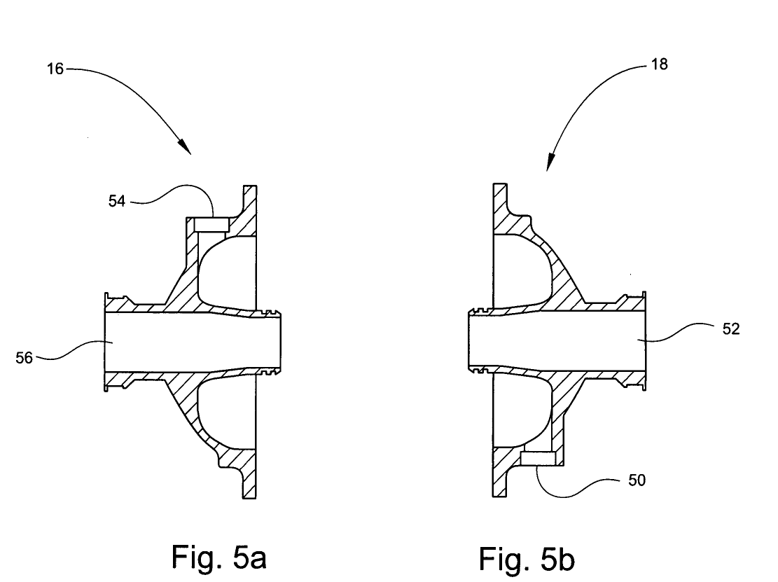

Referring to FIGS. 5a and 5b, there is shown first and second end caps 16 and 18, respectively. The first end cap 16 may include a vacuum port 54 and an inlet port 56. The second end cap 18 includes a filtrate port 50; additionally, the second end cap 18 may further include an auxiliary port 52.

Referring to FIGS. 1, 5a, 5b, and 6, Inlet port 56 is an inlet means for fluid into the center tube 22 via a first connecting tube 58. The inlet port 56 is generally a port, nozzle, fitting, or other opening adapted for facilitating a fluid into contactor 10. The first connecting tube 58 may be a cylindrical tube which fits into center tube 22; in the alternative, the first connecting tube 58 may be an extension of the center tube 22.

The vacuum port 54 is a permeate outlet means for removing gases, which permeate through the walls of the first hollow fiber membranes 31 into the first lumens. The vacuum port 54 is generally a port, nozzle, fitting, or other opening adapted for withdrawing the permeated gas.

The filtrate port 50 is a permeate outlet means adapted for removing fluids, which permeate through the walls of the second hollow fiber membrane 33 into the second lumens. The filtrate port 50 is generally a port, nozzle, fitting, or other opening, which allows the removal of the permeated fluid from the hollow fiber membrane contactor 10.

The auxiliary port 52 is generally a port, nozzle, fitting, or other opening adapted for back flushing contactor 10. Port 52 may be connected to center tube 22 via a second connecting tube 60. Second connecting tube 60 may be a cylindrical tube which fits into the center tube 22; in the alternative, the second connecting tube 60 is an extension of the center tube 22.

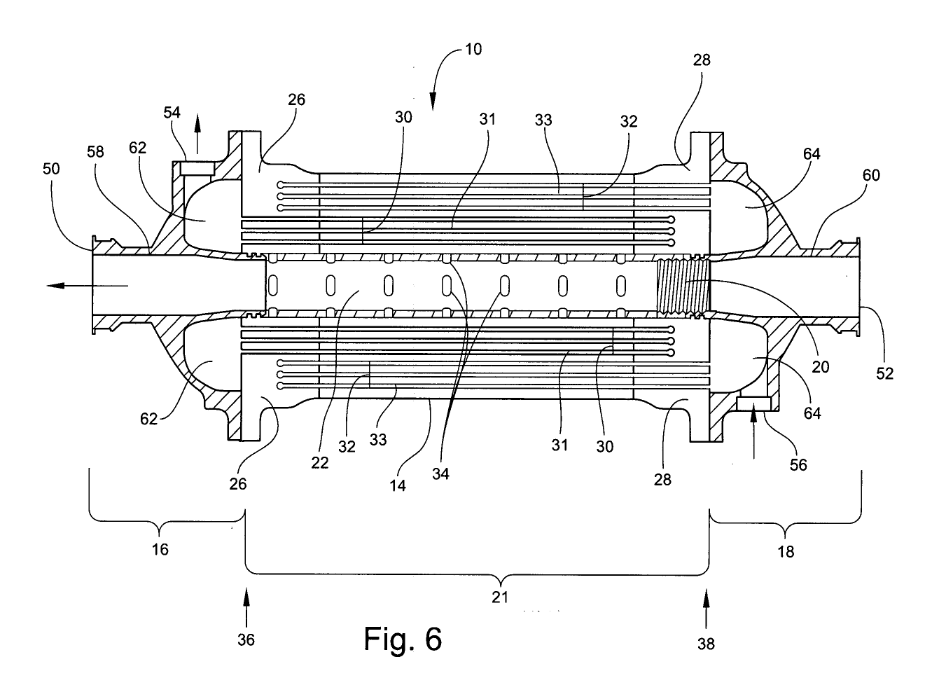

As will be readily apparent to those of ordinary skill, placement of ports may vary, so long as the integrity of the shell side passageway, first lumen side passageway, and second lumen side passageway according to instant invention is maintained as shown in FIG. 6.

In construction, the first and second dissimilar membrane mats 30 and 32 are wrapped around center tube 22 in sequence offset from each other in a length-wise alignment relationship; in the alternative, mats 30 and 32 are wrapped around center tube 22 in alternate layers offset from each other in a length-wise alignment relationship. Next, the respective ends of the first and second mats 30 and 32 are affixed to center tube 22 via potting thereby forming first and second tube sheets 26 and 28. In the alternative, the winding and potting steps may be performed simultaneously. The first and second tube sheets 26 and 28 may then be cut thereby forming alternate open and sealed lumen ends, i.e. the first lumens may be open at the first tube sheet 26 while the second lumens may be sealed at the first tube sheet 26, and the first lumens may be sealed at the second tube sheet 28 while the second lumens may be open at the second tube sheet 28. This structure is, then, disposed within shell 14, and first and second tube sheets 26 and 28 are sealed to the shell 14, for example via O-rings or potting material. End caps 16 and 18 are adjoined to first and second shell ends 40 and 42, respectively; thereby, forming first headspace 62 and second headspace 64 therebetween first and second tube sheets 26 and 28 and end caps 16 and 18, respectively.

In alternative construction, first and second tape mats may be wound perpendicular to the center tube 22. The ends of the first and second tape mats may then be collected in a circular bunch, and connected to a side port, i.e. a vacuum port or a filtrate port, on the shell side.

In operation as shown in FIG. 1, a fluid containing particles and entrained gases enters the contactor 10 via the inlet port 56. The fluid travels into the center tube 22 via the first connecting tube 58, exits the center tube 22 via perforations 14, and is distributed over first and second membrane mats 30 and 32. Vacuum applied via vacuum port 54 forces the entrained gases to permeate through the walls of the first hollow fiber membranes 31 into the first lumens, travel into the first headspace 62, and exit the contactor 10 via vacuum port 54. The permeable portion of the fluid is further forced to permeate through the walls of the second hollow fiber membranes 33 into the second lumens, travels into the second headspace 64, and exits the contactor 10 via filtrate port 50. The retentate portion of the fluid, which is unable to permeate through the walls of the first and second hollow fiber membranes 31 and 33, exits the contactor via retentate port 44. Plug 20 may be removed to back flush contactor 10.

In the alternative operation, as shown in FIG. 6, a fluid containing particles and entrained gases enters the contactor 10 via the inlet port 56. The fluid travels into the second headspace 64, and moves into the second lumens. The permeable portion of the fluid is forced to permeate through the walls of the second hollow fiber membranes 33, and to be distributed over first membrane mat 30. Vacuum applied via port 54 forces the entrained gases to permeate through the walls of the first hollow fiber membranes 31 into the first lumens, travel into the first headspace 62, and exit the contactor via vacuum port 54. The degassed permeable portion of the fluid is further forced to move into the center tube 22 via perorations 34, and then exit the contactor 10 via filtrate port 50. Plug 20 may be removed to back flush contactor 10 to remove any particles unable to permeate through he walls of the second hollow fiber membranes 33.

The present invention may be embodied in other forms without departing from the spirit and the essential attributes thereof, and, accordingly, reference should be made to the appended claims, rather than to the foregoing specification, as indicated the scope of the invention.

We claim:

1. A hollow fiber membrane contactor comprising:
a perforated center tube;
a first membrane mat surrounding said center tube, said first mat comprising a first hollow fiber membrane having a first lumen;
a second membrane mat surrounding said center tube, said second mat comprising a second hollow fiber membrane having a second lumen, wherein said first membrane and said second membrane being dissimilar;
a first tube sheet and a second tube sheet, said tube sheets affixing said first and second mats to said center tube, said first lumen being open at the first tube sheet and closed at the second tube sheet while said second lumen being open at the second tube sheet and closed at the first tube sheet;
a shell surrounding said first and second mats and being sealed to said tube sheets; and
end caps affixed to said shell thereby defining head spaces therebetween said tube sheets and said end caps.

2. The hollow fiber membrane contactor according to claim 1, wherein said first hollow fiber comprising a polymer.

3. The hollow fiber membrane contactor according to claim 2, wherein said polymer being a polyolefin.

4. The hollow fiber membrane contactor according to claim 1, wherein said first hollow fiber having a wall thickness in the range of about 5 to about 1000 μm, a porosity in the range of about 10 to about 80%, and a Gurley number in the range of about 1 to about 2000 seconds/10 cc.

5. The hollow fiber membrane contactor according to claim 1, wherein said second hollow fiber comprising a polymer.

6. The hollow fiber membrane contactor according to claim 5, wherein said polymer being a polyolefin.

7. The hollow fiber membrane contactor according to claim 1, wherein said second hollow fiber having a wall thickness in the range of about 5 to about 1000 μm, a porosity in the range of about 10 to about 80%, and a Gurley number in the range of about 1 to about 2000 seconds/10 cc.

8. The hollow fiber membrane contactor according to claim 1, wherein said first mat having a thickness in the range of about 1 to about 25 cm.

9. The hollow fiber membrane contactor according to claim 1, wherein said second mat having a thickness in the range of about 1 to about 25 cm.

10. The hollow fiber membrane contactor according to claim 1, wherein said first mat and said second mat being wrapped around said center tube in sequence.

11. The hollow fiber membrane contactor according to claim 1, wherein said first mat and said second mat being wrapped around said center tube in alternate layers.

12. The hollow fiber membrane contactor according to claim 1, wherein said first mat and said second mat being leaf mats.

13. The hollow fiber membrane contactor according to claim 1, wherein said first mat and said second mat being looped mats.

14. The hollow fiber membrane contactor according to claim 1, wherein said first mat and said second mat being tape mats.

15. The hollow fiber membrane contactor according to claim 1, wherein said first hollow fiber membrane being a hydrophobic membrane, and said second hollow fiber membrane being hydrophilic.

16. The hollow fiber membrane contactor according to claim 1, wherein said first hollow fiber membrane being a hydrophilic membrane, and said second hollow fiber membrane being hydrophobic.

17. The hollow fiber membrane contactor according to claim 1, wherein said first mat being adapted to degas a fluid, and said second mat being adapted to microfilter said fluid.

18. The hollow fiber membrane contactor according to claim 1, wherein said first mat being adapted to add a gas to a fluid, and said second mat being adapted to microfilter said fluid.

19. The hollow fiber membrane contactor according to claim 1, wherein said first mat being adapted to microfilter a fluid, and said second mat being adapted to ultrafilter said fluid.

20. A hollow fiber membrane contactor comprising:
a perforated center tube having a first end and a second end;
a first mat surrounding said center tube, said first mat comprising a first hollow fiber membrane having a first lumen;
a second mat surrounding said center tube, said second mat comprising a second hollow fiber membrane having a second lumen;
a first tube sheet and a second tube sheet, said first tube sheet affixing said first and second mats to the first end of said center tube, and said second tube sheet affixing said first and second mats to the second end of said center tube;
a shell surrounding said mats and being sealed to said tube sheets,
a first end cap affixed to said shell, said first end cap having a first opening and a second opening therethrough;
a second end cap affixed to said shell, said second end cap having a third opening therethrough;
said first lumens being open at the first tube sheet and closed at the second tube sheet while said second lumens being open at the second tube sheet and closed at the first tube sheet;
said first end cap and said first tube sheet defining a first headspace therebetween, the first opening of said first end cap being in communication with said first lumens via said first headspace, the second opening of first end cap being in communication with said center tube via a connecting tube; and
said second end cap and said second tube sheet defining a second headspace therebetween, the third opening of said second end cap being in communication with said second lumens via said second headspace.

22. A method for making a hollow fiber membrane contactor comprising the steps of:
providing a perforate center tube;
providing a first membrane mat comprising a first hollow fiber membrane having a first lumen;
providing a second membrane mat comprising a second hollow fiber membrane having a second lumen, wherein said first membrane and said second membrane being dissimilar;
winding said first mat and said second mat around said center tube;
potting said first mat and said second mat to said center tube thereby forming a first tube sheet and a second tube sheet, said first lumen being open at the first tube sheet and closed at the second tube sheet while said second lumen being open at the second tube sheet and closed at the first tube sheet;
thereby forming a cartridge;
providing a shell;
disposing said cartridge within said shell;
sealing said tube sheets to said shell;
providing end caps; and
affixing said end caps to said shell.
